(19) United States
(12) Patent Application Publication
(10) Pub. No.: US 2007/0240418 A1
(43) Pub. Date: Oct. 18, 2007

(54) Heat engine

(76) Inventor: Steve HARGREAVES, Broadbeach, QLD (AU)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/628,979

(22) PCT Filed: Jun. 6, 2005
(86) PCT No.: PCT/AT05/00194

§ 371 Date: Jan. 25, 2007

(30) Foreign Application Priority Data
Jun. 8, 2004 (AT) A 995/2004

(51) Int. Cl. F03G 7/00; F03G 6/00

(52) U.S. Cl. 60/641.2; 60/641.8

(57) ABSTRACT

The invention relates to a heat engine comprising a first ambient heat exchanger (1) for exchanging heat with the environment at a first temperature level, a second ambient heat exchanger (2) for exchanging heat with the environment at a second temperature level, a first high-pressure tank (11) for receiving a high-pressure working medium, a second high-pressure tank (12) for receiving a high-pressure working medium, a working machine (31) for producing mechanical energy from the working medium that is discharged from one of the high-pressure tanks (11, 12), and a control device (42) for controlling the progress of the process. High efficiency and great flexibility are obtained by the fact that the first high-pressure tank (11) is provided with a first heat exchanger (21) which is spatially separated from the ambient heat exchangers (1, 2) and can be connected to the first ambient heat exchanger (1) while the second high-pressure tank (12) is provided with a second heat exchanger (22) that is spatially separated from the ambient heat exchangers (1, 2) and can be connected to the second ambient heat exchanger (2).

The invention relates to a heat engine with a first ambient heat exchanger for exchanging heat with the ambient environment at a first temperature level, a second ambient heat exchanger for exchanging heat with the ambient environment at a second temperature level, a first high-pressure tank for receiving a high-pressure working medium, a second high-pressure tank for receiving a high-pressure working medium, a working machine for producing mechanical energy from the working medium that is discharged from one of the high-pressure tanks, and a control device for controlling the progress of the process.

It is known that by utilizing naturally occurring temperature differences it is possible to gain mechanical work. The heat from solar systems or earth-to-air heat exchangers can be used for this purpose.

A solar system for buildings is known from U.S. Pat. No. 5,259,363 A which in addition to gaining heat for heating purposes comprises a turbine for obtaining electrical power. The turbine is part of a conventional cyclic process in which a working fluid is evaporated by supplying heat, thereafter is expanded in the turbine, is condensed and is brought to working pressure again by a feed pump. Such a system may certainly be efficient under optimal conditions, but shows relatively little flexibility when the environmental conditions are fluctuating or suboptimal.

WO 02/075154 A shows an apparatus for condensing a gas by solar power and/or ambient heat. In this apparatus, high-pressure heat exchangers are used which are designed simultaneously as collectors for heat exchange with the ambient environment. A high-pressure heat exchanger can be configured as a solar collector. A pneumatic cylinder is provided as a working machine to expand a high-pressure medium from the high-pressure part of the high-pressure heat exchanger. After achieving the pressure equalization, the processed working medium in the high-pressure part of the high-pressure heat exchanger is supplemented in order to allow the start of a new working cycle. With a known apparatus of this kind it is possible to simultaneously use or produce heat, refrigeration and mechanical energy; the efficiency of the processes is very low however and the flexibility with respect to possible adjustments to different requirements and ambient conditions is limited. A further disadvantage of the known solution is that the collectors which are used as ambient heat exchangers are configured simultaneously as high-pressure tanks and therefore need to be provided with a very sturdy mechanical arrangement. This increases the constructional efforts to a considerable extent.

CH 647 590 A describes a method and an apparatus for gaining useful energy from low-degree heat sources. This apparatus may comprise high-pressure tanks in certain embodiments which are filled with a molecular sieve zeolite.

It is the object of the present invention to provide a heat engine of the kind mentioned above which avoids these disadvantages and optimally utilizes the available temperature levels and shows high efficiency. Furthermore, a simple constructional configuration shall be achieved. It is a further object of the invention to provide a method which allows high efficiencies and high flexibility.

It is provided for in accordance with the invention that the first high-pressure tank comprises a first heat exchanger which is separated in respect of space from the ambient heat exchangers and can be connected with the first ambient heat exchanger and that the second high-pressure tank comprises a second heat exchanger which is separate in respect of space from the ambient heat exchangers and can be connected with the second heat exchanger and that a compressor is provided which is mechanically coupled with the working machine, with the compressor preferably being arranged as a high-pressure compressor. It is thus possible to bring a working medium to a high pressure in order to store the same or process the same as required.

The relevant aspect of the invention is on the one hand that a working medium is used for converting the thermal energy, which medium is under a high pressure in order to achieve high levels of efficiency. On the other hand, a considerably quicker working cycle can be achieved by the spatial separation of the collectors, i.e. the ambient heat exchangers, because it is possible to switch over directly between heating and cooling. A further advantage of the system in accordance with the invention is that no feed pump is required in order to fill the high-pressure tank with the working medium because the same substantially flows back and forth between the high-pressure tanks. Since the ambient heat exchangers are only flowed through by a low-pressure medium, conventional solar collectors, earth-to-air heat exchangers or the like can be used, which simplifies the constructional configuration and lowers the costs.

A special advantage of the present invention is that by separating the components it is possible to achieve a high flexibility concerning the utilization of the currently available temperature levels.

A solution of the invention which is especially favorable with respect to its construction is given when the working machine is arranged as a turbine. The working machine can be reversible, i.e. it can be designed to operate in both directions, thus reducing the requirements placed on the circuitry.

An increase in the efficiency can be achieved in such a way that the first high-pressure tank comprises a fifth heat exchanger in addition to the first heat exchanger, and that the second high-pressure tank comprises a sixth heat exchanger in addition to the second heat exchanger. It is especially advantageous in this connection when the first ambient heat exchanger is optionally connectable with the fifth and sixth heat exchanger and that the second ambient heat exchanger is optionally connectable with the first and second heat exchanger. The circuit is preferably configured in such a way that the first ambient heat exchanger with the fifth and sixth heat exchanger is arranged in a closed heat carrier cycle and that the second ambient heat exchanger with the first and second heat exchanger is arranged in a further closed heat carrier cycle. The first and second heat exchanger are used in normal operation to supply heat in an alternating manner to the first and second high-pressure tank, whereas heat is withdrawn from the other of the two high-pressure tanks via the fifth or sixth heat exchanger. Notice must be taken that under special operation conditions such as during the night, heat can be emitted via an ambient heat exchanger which is normally used for absorbing heat such as a solar collector for example, whereas heat is absorbed via another ambient heat exchanger which can be configured as an earth-to-air exchanger for example. As a result of the special flexibility of the apparatus in accordance with the invention it is also possible to utilize such unusual ambient environmental conditions in order to convert heat in mechanical work. It is especially also possible to provide an ambient heat exchanger for heating or cooling buildings or installations.

The flexibility in use can be further increased in that furthermore there are provided a third high-pressure tank and a fourth high-pressure tank which are optionally connectable with the working machine. The supply and discharge of heat preferably occurs in such a way that the third high-pressure tank comprises a third heat exchanger and the fourth high-pressure tank comprises a fourth heat exchanger.

An especially preferable embodiment of the present invention provides that the third heat exchanger and the fourth heat exchanger are optionally connectable with the compressor. In addition, the third heat exchanger and the fourth heat exchanger can be optionally connectable with a further working machine.

A further extension of the invention provides that the third high-pressure tank comprises in addition to the third heat exchanger a seventh heat exchanger and that the fourth high-pressure tank comprises in addition to the fourth heat exchanger an eighth heat exchanger, with the seventh and eighth heat exchangers being especially connectable to the compressor and a working machine in a high-pressure heat carrier cycle. In this way, a previously unparalleled variability with respect to the utilization of a large variety of ambient conditions is achieved. Short-term periods in which the energy demand exceeds the available energy can be preferably bridged in such a way that additional high-pressure buffer storage units are provided.

The present invention further relates to a method for converting thermal energy into mechanical work in which heat is absorbed from the ambient environment at a first temperature level by a first ambient heat exchanger and is conveyed to a working medium under high pressure present in a high-pressure tank, and in which a second ambient heat exchanger exchanges heat at a second temperature level with the ambient environment, with the working medium under high pressure being expanded in a working machine.

This method is characterized in accordance with the invention in such a way that a first high-pressure tank is brought into connection thermally in an alternating fashion with the first ambient heat exchanger and with the second ambient heat exchanger. High levels of efficiency can be achieved by short cycle times.

A preferred variant of the method in accordance with the invention provides that a second high-pressure tank is brought into connection thermally in an alternating manner with the first ambient heat exchanger and with the second ambient heat exchanger, so that the first high-pressure tank is thermally in connection with an ambient heat exchanger and the second high-pressure tank is thermally in connection with the other ambient heat exchanger.

The method is conducted especially in such a way that alternatingly in a first working cycle the working medium is heated in the first high-pressure tank via a first heat exchanger, such that the first heat exchanger is brought into connection with the first ambient heat exchanger, whereas simultaneously the second high-pressure tank is cooled via a sixth heat exchanger, such that the sixth heat exchanger is brought into connection with the second ambient heat exchanger, and in a second work cycle the working medium in the second high-pressure tank is heated via a second heat exchanger, such that the second heat exchanger is brought into connection with the first ambient heat exchanger, whereas simultaneously the first high-pressure tank is cooled via a fifth heat exchanger, such that the fifth heat exchanger is brought into connection with the second ambient heat exchanger.

The invention is now explained in closer detail by reference to the embodiments shown in the enclosed drawings, wherein:

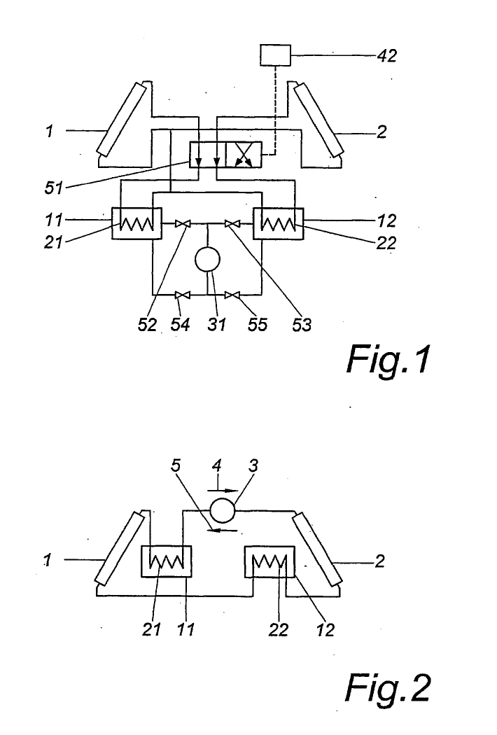

FIG. 1 shows a schematic circuit diagram outlining the fundamental concept of the invention;

FIG. 2 shows a variant of the circuit of FIG. 1, and

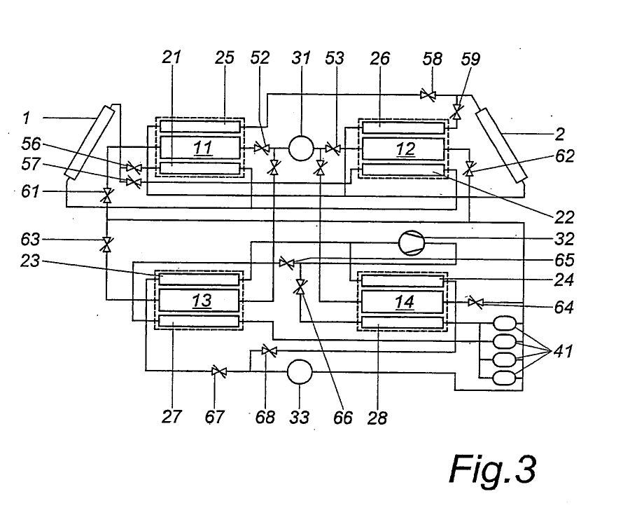

FIG. 3 shows a preferred embodiment of the invention in a circuit diagram.

FIG. 1 schematically shows the fundamental concept of the present invention. A first ambient heat exchanger 1 is configured as a solar collector for example. A second ambient heat exchanger 2 is a ground heat collector. It is irrelevant for the present invention whether it concerns a depth collector which is arranged in a drilled hole up to a depth of 100 m or more or a flat collector which is dug into the ground in a depth of approximately 1 to 2 m over a large surface area. A first high-pressure tank 11 and a second high-pressure tank 12 are provided in a manner so as to be spatially separated from the ambient heat exchangers 1, 2, which tanks comprise a first heat exchanger 21 and a second heat exchanger 22, respectively. A selector valve 51 ensures that the first ambient heat exchanger 1 is optionally connected with the first heat exchanger 21 or the second heat exchanger 22. At the same time, the second ambient heat exchanger 2 is connected with the respectively other heat exchanger 22, 21. Circulating pumps, which are not shown, ensure the conveyance of a working medium to the heat carrier cycles of the first and second ambient heat exchangers 1, 2. A control device 42 ensures the respective optimal changeover of the selector valve 51. As a result of the heating of one of the high-pressure tanks 11, 12 by the respective heat exchanger 21, 22, the internal pressure in said high-pressure tank 11, 12 will increase, thus leading to a pressure difference relative to the other high-pressure tank 12, 11. Said pressure difference can be converted into mechanical work by a working machine 31 which is configured as a turbine for example. After reaching the pressure equalization, the selector valve 51 is reversed, so that now the other high-pressure tank 12, 11 is heated and the expansion occurs in a different direction by the working machine 31. The working machine 31 can be provided with a reversible configuration, or valves 52, 53, 54 55 are used in order to ensure the required guidance of the working medium between the high-pressure tanks 11, 12 and the working machine 31.

In the embodiment of FIG. 2, a coolant cycle is arranged in such a way that the first ambient heat exchanger 1, the first heat exchanger 21, the second ambient heat exchanger 2 and the second heat exchanger 22 are switched successively in a closed cycle. A reversible circulating pump 3 is able to pump the working medium of said circulation optionally in any of the two directions. If the circulating pump 3 is driven in the direction of arrow 4, the heat from the ambient heat exchanger 2 via the first heat exchanger 21 is used for heating the first high-pressure tank 11, whereupon the working medium flows into the colder ambient heat exchanger 2 and thereafter cools the second high-pressure tank 12 via the second heat exchanger 22. If the circulating pump 3 is reversed in order to convey the working medium in the direction of arrow 5, the working medium which flows from the first ambient heat exchanger 1 heats the second high-pressure tank 12 via the second heat exchanger 22 and then flows through the second ambient heat exchanger 2 and then cools the first high-pressure tank 11 via the first heat exchanger 21. The remaining circuitry substantially corresponds to that of FIG. 1. In this embodiment it is possible to change over between heating and cooling of the two high-pressure tanks 11, 12 without any special valves.

It is understood that FIGS. 1 and 2 only schematically show the fundamental functional principles of the present invention. Modifications are possible in numerous ways. Thus it is possible to provide more than two high-pressure tanks 11, 12 and to connect the same according to a predetermined switching cycle with the ambient heat exchangers 1, 2 and thus to heat or cool them. Further modifications of the invention are shown in FIG. 3.

In the embodiment of FIG. 3, the first high-pressure tank 11 is provided with a first heat exchanger 21 and a fifth heat exchanger 25. The second high-pressure tank 12 is equipped with a second heat exchanger 22 and a sixth heat exchanger 26. The first ambient heat exchanger 1 can be connected optionally via valves 56, 57 with the first heat exchanger 21 and the second heat exchanger 22. At the same time, the second ambient heat exchanger 2 is optionally connectable via valves 58, 59 with the fifth heat exchanger 25 and the sixth heat exchanger 26. The working machine 31 is in connection with the first high-pressure tank 11 and the second high-pressure tank 12 via valves 52, 53. As a result of the alternating heating and cooling of the two high-pressure tanks 11, 12, the working machine 31 can be driven, such that the working medium is expanded by the high-pressure tank 11, 12 with higher pressure into the other high-pressure tank 12, 11 with lower pressure. The pressure of the working medium is in the magnitude of approximately 200 bars; it can also be up to 300 bars and more.

The first and second high-pressure tank 11, 12 are in connection with a third high-pressure tank 13 and a fourth high-pressure tank 14 via high-pressure lines with valves 61, 62, 63, 64. The third high-pressure tank 13 comprises a third heat exchanger 23 and seventh heat exchanger 27, whereas the fourth high-pressure tank 14 comprises a fourth high-pressure tank 24 and an eighth heat exchanger 28. The third, fourth, seventh and eighth heat exchangers 23, 24, 27, 28 are in connection with a compressor 32 via valves 65, 66, which compressor is driven by the working machine 31.

Several high-pressure buffer storage units 41 are in connection with the high-pressure tanks 11, 12, 13, 14 via valves 61, 62, 63, 64 and are further coupled with the seventh and eighth heat exchanger 27, 28. In addition, the high-pressure cycle is in connection with the seventh and eighth heat exchanger 27, 28 with a further working machine 33 which on its downstream side is connected via valves 67, 68 with the third and fourth heat exchanger 23, 24.

The operational characteristics of the apparatus in accordance with the invention are now explained below in closer detail:

The high-pressure tanks 11, 12 are initially filled with a working medium with an equal pressure of 200 bars for example. The working medium can be air, but it can also concern a suitable other gas. It is now assumed that through insulation on the first ambient heat exchanger 1 or through any other heating the temperature in said ambient heat exchanger 1 will rise, whereas the temperature in the ambient heat exchanger 2 will be low because it is situated in the shade, e.g. within a building or in the soil. In a first work cycle, the valves 56 and 59 are opened and the valves 57 and 58 are closed. That is why the first high-pressure tank 11 is heated via the first heat exchanger 21, whereas the second high-pressure tank 12 is cooled via the sixth heat exchanger 26. The pressure in the first high-pressure tank 11 which has increased through the increase in the temperature is processed through the working machine 31, and working medium is supplied to the second high-pressure tank 12. The working machine 31 is mechanically coupled with the compressor 32 which compresses the working medium to high-pressure and guides it at first through the seventh and/or eighth heat exchanger 27, 28 where the compression heat is conveyed to the third and/or fourth high-pressure tank 13, 14. The working medium is stored under high pressure in the high-pressure buffer storage units 41.

The change between heating of the first and second high-pressure tank 11, 12 has already been explained above in detail. After several cycles the temperature and thus the pressure in the third and/or fourth high-pressure tank 13, 14 has risen to such an extent that the working medium can be expanded and processed via the further working machine 33. The expanded and cooled working medium is guided through the third and/or the fourth heat exchanger 23, 24 and cools the respective high-pressure tank 13, 14. In the case of a respective control it is possible to produce refrigeration which can be used for cooling buildings or installations.

The present invention allows converting thermal energy into mechanical work with high efficiency and an utmost amount of flexibility.

1-32. (canceled)

33. A heat engine comprising:
a first ambient heat exchanger for exchanging heat with the ambient environment at a first temperature level;
a second ambient heat exchanger for exchanging heat with the ambient environment at a second temperature level;
a first high-pressure tank for receiving a working medium under high pressure comprising a first heat exchanger which is spatially separated from the ambient heat exchangers and can be connected with the first ambient heat exchanger;
a second high-pressure tank for receiving a working medium under a high pressure comprising a second heat exchanger which is spatially separated from the ambient heat exchangers and can be connected with the second heat exchanger;
a working machine for gaining mechanical work from the expansion of the working medium from a high-pressure tank;
a control device for controlling the process; and
a compressor which is mechanically coupled with the working machine.

34. A heat engine according to claim 33, wherein the working machine is a turbine.

35. A heat engine according to claim 33, wherein the compressor is a high-pressure compressor.

36. A heat engine according to claim 33, wherein the first ambient heat exchanger is connected in a closed heat carrier cycle with the first heat exchanger.

37. A heat engine according to claim 33, wherein the first ambient heat exchanger is connected in a closed heat carrier cycle with the second heat exchanger.

38. A heat engine according to claim 33, wherein the second ambient heat exchanger is connected in a closed heat carrier cycle with the first heat exchanger and/or the second heat exchanger.

39. A heat engine according to claim 33, wherein the working machine is reversible.

40. A heat engine according to claim 33, wherein the first high-pressure tank comprises a fifth heat exchanger in addition to the first heat exchanger, and the second high-pressure tank comprises a sixth heat exchanger in addition to the second heat exchanger.

41. A heat engine according to claim 40, wherein the first ambient heat exchanger is connected with the fifth and sixth heat exchanger and the second ambient heat exchanger is connected with the first and second heat exchanger.

42. A heat engine according to claim 41, wherein the first ambient heat exchanger with the fifth and sixth heat exchanger is arranged in a closed heat carrier cycle and the second ambient heat exchanger with the first and second heat exchanger is arranged in a further closed heat carrier cycle.

43. A heat engine according to claim 33, wherein one of the first ambient heat exchanger and the second ambient heat exchanger is a solar collector.

44. A heat engine according to claim 33, wherein one of the first ambient heat exchanger and the second ambient heat exchanger is an earth-to-air exchanger.

45. A heat engine according to claim 33, wherein one of the first ambient heat exchanger and the second ambient heat exchanger is a heat exchanger for heating or cooling rooms or installations.

46. A heat engine according to claim 33, wherein a third high-pressure tank and a fourth high-pressure tank are further provided which are optionally connectable with the working machine.

47. A heat engine according to claim 46, wherein the third high-pressure tank comprises a seventh heat exchanger in addition to the third heat exchanger and the fourth high-pressure tank comprises an eighth heat exchanger in addition to the fourth heat exchanger.

48. A heat engine according to claim 47, wherein seventh heat exchanger and the eighth heat exchanger are connected in a high-pressure heat carrier cycle with the compressor and with a working machine.

49. A heat engine according to claim 46, wherein the third and/or fourth high-pressure tank are insulated against the ambient environment.

50. A heat engine according to claim 46, wherein the third high-pressure tank comprises a third heat exchanger and the fourth high-pressure tank comprises a fourth heat exchanger.

51. A heat engine according to claim 50, wherein the third heat exchanger and the fourth heat exchanger are connected with the compressor.

52. A heat engine according to claim 50, wherein the third heat exchanger and the fourth heat exchanger are connected with a further working machine.

53. A heat engine according to claim 33, wherein high-pressure buffer storage units are additionally provided.

54. A method for converting thermal energy into mechanical work in which heat is absorbed from the ambient environment at a first temperature level by a first ambient heat exchanger and is conveyed to a working medium under high pressure present in a high-pressure tank, and in which a second ambient heat exchanger exchanges heat at a second temperature level with the ambient environment, with the working medium under high pressure being expanded in a working machine, wherein a first high-pressure tank is brought into thermal connection in an alternating manner with the first ambient heat exchanger and the second ambient heat exchanger, and a compressor is driven by the working machine which compresses the working medium or a further working medium.

55. A method according to claim 54, wherein a second high-pressure tank is brought into connection thermally in an alternating manner with the first ambient heat exchanger and with the second ambient heat exchanger, so the first high-pressure tank is thermally in connection with an ambient heat exchanger and the second high-pressure tank is thermally in connection with the other ambient heat exchanger.

56. A method according to claim 54, wherein the working medium in the first high-pressure tank is heated and cooled via a first heat exchanger, such that the first heat exchanger is brought into connection in an alternating manner with the first ambient heat exchanger and with the second ambient heat exchanger.

57. A method according to claim 54, wherein the working medium is heated and cooled in the first high-pressure tank via a first heat exchanger, such that the first heat exchanger is brought into connection in an alternating manner with the first ambient heat exchanger and with the second ambient heat exchanger.

58. A method according to claim 54, wherein in a first working cycle the working medium is heated in the first high-pressure tank via a first heat exchanger in an alternating manner, such that the first heat exchanger is brought into connection with the first ambient heat exchanger, whereas simultaneously the second high-pressure tank is cooled via a sixth heat exchanger, such that the sixth heat exchanger is brought into connection with the second ambient heat exchanger, and in a second work cycle the working medium in the second high-pressure tank is heated via a second heat exchanger, such that the second heat exchanger is brought into connection with the first ambient heat exchanger, whereas simultaneously the first high-pressure tank is cooled via a fifth heat exchanger, such that the fifth heat exchanger is brought into connection with the second ambient heat exchanger.

59. A method according to claim 54, wherein the compressor heats a working medium which conveys the heat in an alternating manner via a third and a fourth heat exchanger to a working medium which is present in a third or fourth high-pressure tank.

60. A method according to claim 54, wherein the working medium from the first and second high-pressure tank and the third and fourth high-pressure tank is expanded in a further working machine.

61. A method according to claim 54, wherein the working medium under high pressure is stored in further high-pressure buffer storage units.

61. A method according to claim 54, wherein the working medium under high pressure is stored in further high-pressure buffer storage units.

62. A method according to claim 54, wherein compressed air is used as a working medium, which is used for driving further working machines such as pumps, generators, motor vehicles or the like.

63. A method according to claim 54, wherein the alternating delivery of the heat exchangers is performed by reversing a conveyor pump.

64. A method according to claim 54, wherein the heat produced during the compression is used for heating buildings or installations.

65. A method according to claim 54, wherein the refrigeration produced during the expansion is used for cooling buildings or installations.
